(19) United States
(12) Patent Application Publication
(10) Pub. No.: US 2006/0283244 A1
(43) Pub. Date: Dec. 21, 2006

(54) Measuring device for determining the characteristics and the level of a brake fluid in a motor vehicle

(76) Inventors: Jurgen Schonlau, Walluf (DE); Manfred Ruffer, Sulzbach (DE); Jose Gonzalez, Bad Oeynhausen (DE); Thomas Voigtmann, Friedrichsdorf-Koppern (DE)

Correspondence Address: Craig Hallacher;Continental Teves Inc, One Continental Drive, Aurburn Hills, MI, 48326, US

(21) Appl. No.: 10/570,825

(22) PCT Filed: Sep. 2, 2004
(86) PCT No.: PCT/EP04/52003

§ 371 Date: Mar. 6, 2006

(30) Foreign Application Priority Data
Sep. 4, 2003 (DE) 10341263.8
Jul. 20, 2004 (DE) 102004035079.5

(51) Int. Cl. G01F 23/00

(52) U.S. Cl. 73/291

(57) ABSTRACT

Disclosed is a measuring device (1) for determining one or more characteristics of a fluid or the level of this fluid in a reservoir (8). In particular, the device is utilized in the brake fluid reservoir of a motor vehicle brake system that may be electronically controlled. The device includes an integrated measuring electronic system (2), a sensor device (4), an electric supply line (18, 26), and an electric connecting line (9).

### BACKGROUND OF THE INVENTION

The present invention relates to a measuring device for determining the characteristic(s) of a fluid and/or the filling level of this fluid in a reservoir (8) receiving the fluid, which is arranged in particular in the brake fluid reservoir of a motor vehicle brake system that is preferably controlled electronically.

Different methods and devices for determining the moisture content in a brake fluid are known in the art. In some methods, the quality of the hygroscopic brake fluid, in particular the water contents, is determined by determining the boiling point of the fluid, for example.

The device for determining the quality by using the boiling temperature as known from EP 0 513 004 is so designed that the sensor element is configured as at least one linear conductor, e.g. a wire. Apparatus features which are directed to an arrangement in a brake fluid reservoir cannot be taken from this publication.

The device described in EP 0 289 499 B1 concerns a brake fluid testing appliance where a bubble boiling zone is produced in a measuring cell. The device concerned is not appropriate for being installed into a motor vehicle because it is designed as an appliance.

The device which is described rather schematically in DE 101 47 804 A1 comprises a sensor element and a heating element in a cylinder-shaped measuring chamber. It does not disclose a special embodiment which would render the sensor apt for use in a brake fluid reservoir.

DE 197 41 892 C2 additionally discloses in terms of principle how to measure the filling level in a brake fluid reservoir apart from determining the quality of the brake fluid. DE 197 41 892 C2 mainly describes a measuring method. A measuring device for implementing the method is not disclosed.

Hence, it remains to be stated that the concrete constructive features of a measuring device which can be employed reliably in the motor vehicle and can be manufactured at low cost has so far not become known from the prior art.

### SUMMARY OF THE INVENTION

In view of the above, the invention has for its objective to disclose a device for implementing the principally per se known measuring methods, which can be produced at low cost and satisfies the existing and future requirements in car making.

According to the invention, this object is achieved by luding a measuring electronic system, a sensor connected to the measuring electronic system, an electric supply line connecting the measuring electronic system and the sensor device, and an electric connecting line providing a connection between the measuring device and an electronic control unit for transmissiting the sensor signals.

A special feature of the measuring device of the invention involves that the measuring electronic system is integrated in the measuring device. This arrangement renders it possible to avoid electrically shielding the electric connecting line by which the measuring device can be connected to an electronic control unit for the transmission of sensor signals. Further, important advantages are achieved in terms of the reliability and the manufacturing costs of the sensor.

The favorable possibility of manufacturing the measuring device of the invention as a plug-in cartridge allows realizing different installation positions in compliance with the individual wishes of the car makers.

Further preferred embodiments can be seen in the following description of the Figures.

The invention will be explained in detail in the following by way of examples.

### BRIEF DESCRIPTION OF THE DRAWINGS

In the drawings:

FIG. 1 shows an example for a measuring device which is attached in the reservoir cover;

FIGS. 2, 3 show examples for alternative places of installation of the measuring device;

FIG. 4 shows another example for a measuring device according to the invention;

FIG. 5 shows an example for a measuring device with a shaped part for sealing that is integrated into a reservoir cover, and;

FIG. 6 shows an example for a measuring device with sealing rings that can be screwed into the reservoir.

### DETAILED DESCRIPTION OF THE DRAWINGS

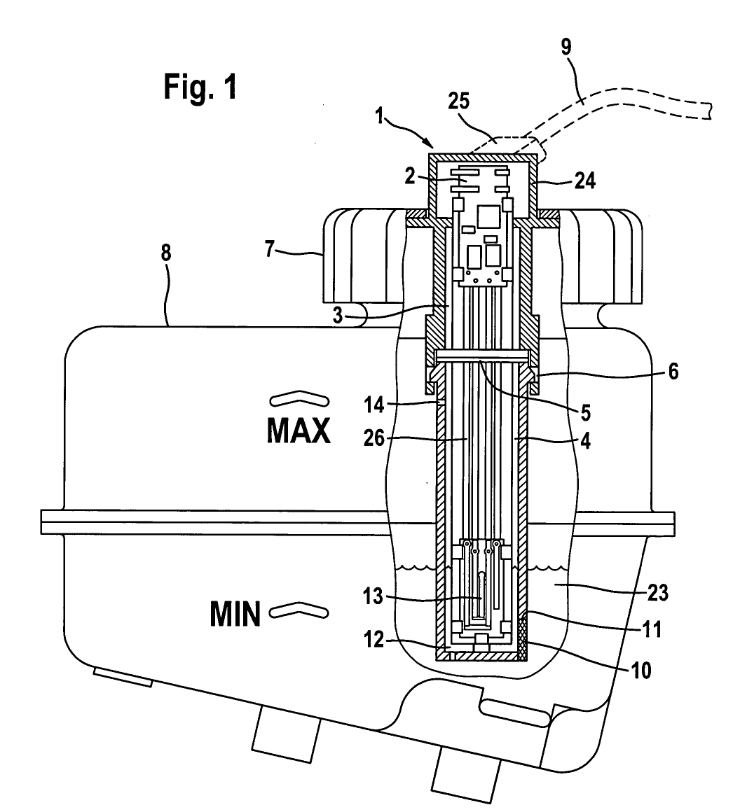

Measuring device 1 comprises an integrated evaluating electronic system 2 in FIG. 1. The electronic components of the measuring electronic system 2 are arranged on a component carrier. It is a special feature of the measuring device 1 that the measuring electronic system 2 is integrated into the measuring device 1. The integration of the measuring device achieves a number of advantages. Thus, the possible signal amplification e.g. obviates the need for an electric shielding of the sensor cable. Further, the measuring device 1 does not comprise movable parts. The connection of the printed circuit board is done by way of plane conducting tracks 26 which can be produced using a punching frame. However, a conductively coated foil material may also be concerned, which offers the advantage of enhanced elasticity. The housing part of the measuring device is configured in general like a cartridge and includes in the area of the sensor elements a partly permeable opening 11 through which the fluid can enter into the interior of the housing part. This opening is e.g. closed by a filter 10. An appeased chamber 12 is hereby produced after the sensor has immersed into the brake fluid 23, providing a suitable measuring volume for the sensor 13. In the simplest case, however, a simple recess in the wall of the measuring device is concerned, if it ensures the desired extent of fluid exchange between the reservoir and the measuring chamber. The housing part can have one or more additional ventilation apertures 14. The measuring device is rotatably mounted in the cover 7 of a brake fluid reservoir 8 so that connecting lines 9 which extend from the engine compartment to the outside of the measuring device, and e.g. lead to the ECU of an electronic brake system, can be connected more easily in the desired direction. The device includes a bottom housing part for the sensor element(s) and a top housing part, sealed therefrom, for the electronics. The area of the electronics 3 and the area of the sensor system 4 are hermetically isolated from each other by means of a separating element 5. The housing parts can be interconnected in operative manner in a per se known fashion, preferably by means of a catch 6. A molecular bond is also feasible.

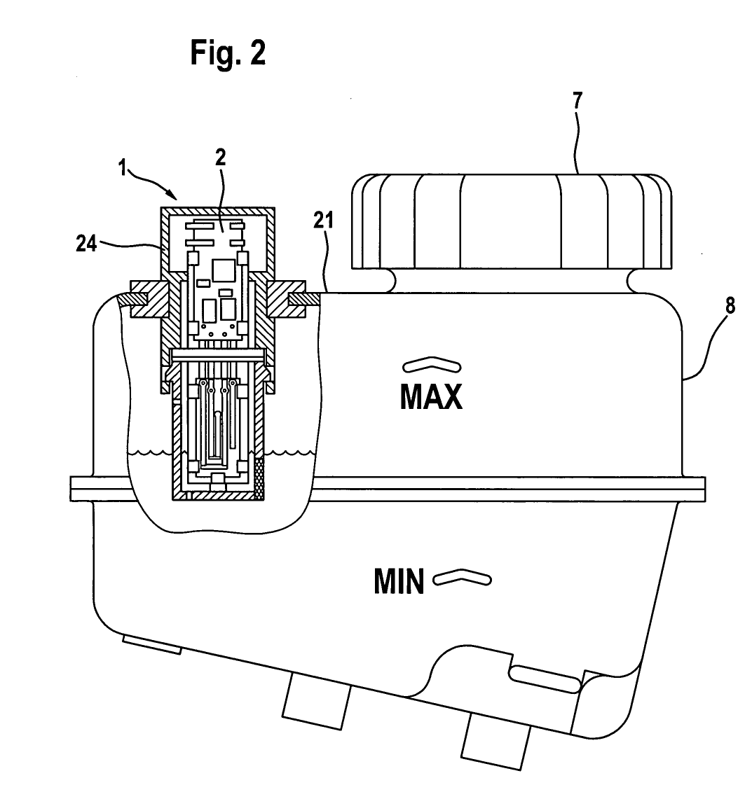

In FIG. 2, the measuring device is connected to the wall of the brake fluid reservoir. This is easily possible because the measuring device is designed as a plug-in cartridge.

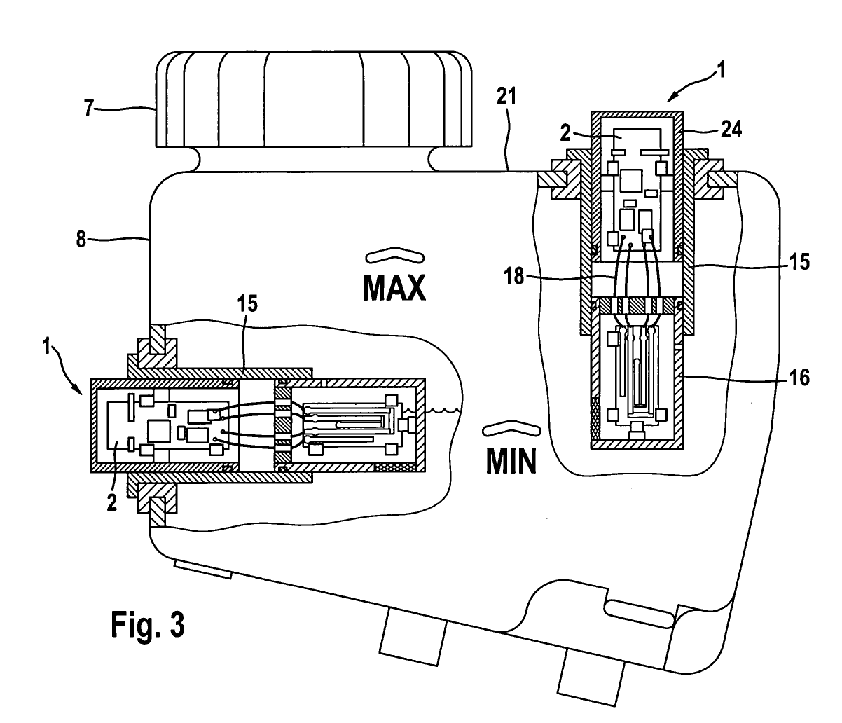

In FIG. 3, two measuring devices are illustrated in a horizontal and a vertical arrangement to show different mounting positions. The overall length of the illustrated multi-part housing of the measuring device can be adapted to the respective reservoir shape depending on the type of vehicle so that a sufficiently deep immersion of the sensor into the brake fluid is safeguarded. Appropriate seals are used to seal the housing parts in relation to each other in such a way that displacement of the housing parts in each other is possible. It is preferred that the housing parts are manufactured in the shape of cylinders, with the outside housing part 15 having a diameter slightly larger than the diameter of the inside housing part 16 which can be slipped into the outside housing part 15. The housing part containing the electronics is hermetically isolated from the housing part containing the measuring elements. A sealed passage for the electric lines is provided in the area of the hermetic sealing. Glass 21 can preferably be provided for the sealing. Alternatively, electric connecting elements such as plugs, contacts, and like elements, can be provided in this area.

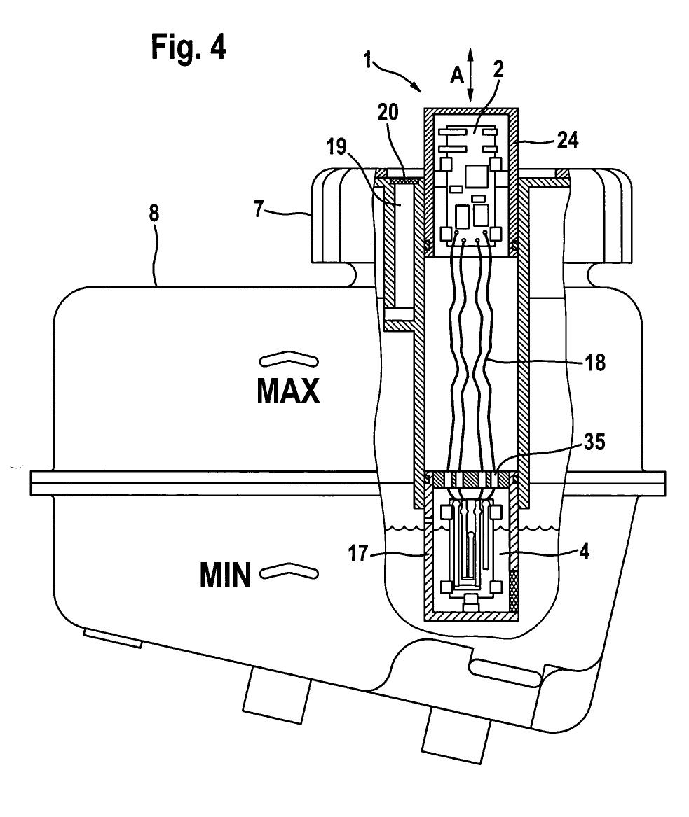

In FIG. 4, the electric lines which connect the measuring electronic system to the area of the sensor system 4 in the bottom housing part 17 are configured as flexible lines 18 which, compared to rigid lines, exhibit the advantage that they cannot be damaged when the bottom housing part 17, being hermetically sealed, is displaced for the purpose of length variation. Alternatively, the flexible lines can be simple insulated wires. In addition, the fluid reservoir includes one or more openings 19 in the area of the housing and/or the closure for ventilation of the reservoir, the opening(s) being preferably closed by a textile membrane 20 such as a breathable textile strip made of GoreTex®. The ventilation arrangement described hereinabove can be shaped at the housing of the measuring device. The measuring device 1 in whole can be shifted in a longitudinal direction A within the mounting support arranged in the cover. Further, the plug cap 24 including the electronics can be turned in the cover about axis A by a defined angular range in order to permit connection of an angled-off plug 25 which is connected to line 9 in different directions.

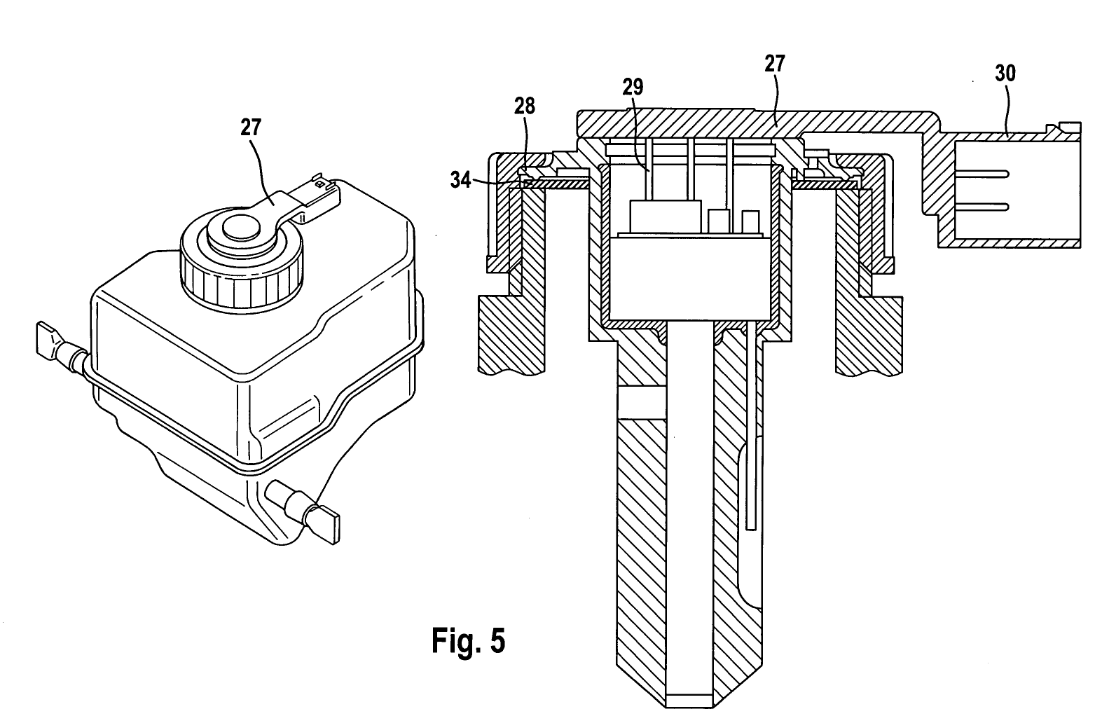

FIG. 5 shows another possibility of integrating a brake fluid quality sensor into a reservoir cover. According to FIG. 5, the sensor is integrated into a series reservoir cover of a standard brake fluid reservoir, in such a way that there is also a venting arrangement in the cover. The outside housing (sensor carrier) is a shaped part which accommodates all single parts of the sensor such as sensor head, electrode, electronics and seal for the separation of electronics and sensor elements (temperature feeler and heating element). Inserted into the top part of the sensor, in the area of the electronics, is a shaped part accommodating the electronics and, additionally, having sealing qualities in relation to the sensor electrodes. The integral shaped part made of an elastomer bears against the walls in the area of the electronics and reliably seals the electronic component in the area of the hermetic isolation between electronics and electrodes. In the area where the cover is pressed on, an annular washer 34 for sealing the reservoir is placed below an annular sensor abutment collar 28. Towards the engine compartment, the electronics is sealed by a plug extension 27 which guides the contacts 29 leading from the sensor plug 30 to the electronics.

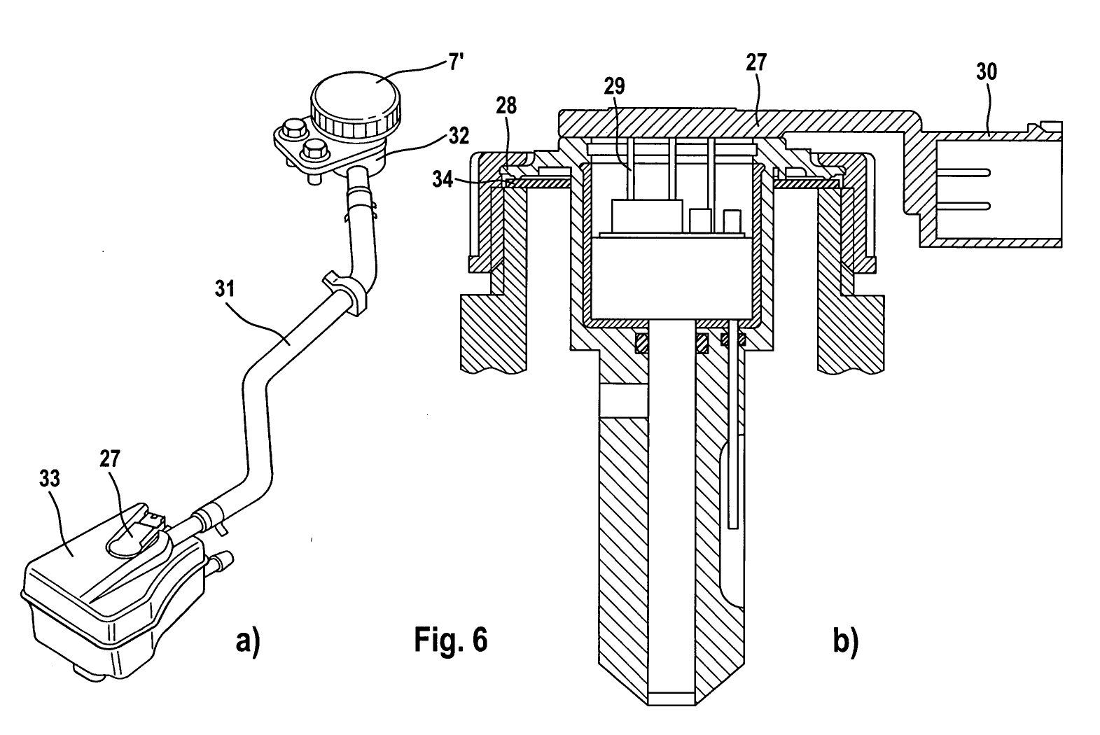

FIG. 6a) shows a separate, lowered reservoir 33 with a quality sensor that is connected to a separated smaller filling reservoir 32 by way of a connecting line 31. Cover 7′ is arranged at the filling reservoir 32 for filling the brake fluid.

The quality sensor in FIG. 6b), shown in a cross-sectional view, displays a sensor similar to FIG. 5, with the differences that sealing between the electronics and sensor elements is done by means of ring seals, and a separate sealing ring is provided in each case for sealing towards the sensor head with the quality electrode and towards the electrode for the filling level. When the venting arrangement in the area of the cover as illustrated in FIG. 5 is dispensed with, there is the possibility of using the quality sensor in the separated reservoir arrangement illustrated in FIG. 6a).

1-12. (canceled)

13. A measuring device (1) for determining at least of one or more characteristics of a fluid and a level of the fluid in a reservoir (8) receiving the fluid, which is arranged in a brake fluid reservoir of a motor vehicle brake system that is controlled electronically, the device comprising:
a measuring electronic system (2) integrated into the measuring device;
a sensor device (4) which is connected to the measuring electronic system in an electrically conductive fashion and used to determine at least one of the fluid characteristics and to determine the filling level of the fluid in the reservoir receiving the fluid,
an electric supply line (18, 26) providing an electric connection between the measuring electronic system and the sensor device, and
an electric connecting line (9) providing a connection between the measuring device and an electronic control unit for transmission of the sensor signals.

14. A measuring device according to claim 12, wherein the measuring device includes two or multi-part separable housing parts being configured as a cartridge, and at least one of the housing parts is provided with an area that is partly permeable for the fluid or with an opening which presets a defined flow resistance.

15. A measuring device according to claim 12, wherein inside the measuring device there is a zone of separation being used to protect the electronics against the brake fluid, with a result that in particular the area of the device is hermetically closed in which the electronics is accommodated.

16. A measuring device according to claim 15, wherein the zone of separation is arranged in the area where the housing parts are separated.

17. A measuring device according to claim 12, wherein the electric supply line is formed of wires or plane conductors which are led in a seal-tight manner especially through the zone of separation.

18. A measuring device according to claim 12, wherein the device is assembled of several parts and can be modified in terms of length in order to adapt to various reservoir shapes, or at least the outside housing is shaped integrally of one material.

19. A measuring device according to claim 12, wherein the measuring device is mounted at the top housing part (21) or the cover (7) or into the wall or into the bottom of the reservoir.

20. A measuring device according to claim 19, wherein the measuring device (1) is fixed in an area of the reservoir wall or the reservoir cover and is displaced axially in the direction of the longitudinal axis of the measuring device for the adjustment in length, or can be turned by a minimum angle about the longitudinal axis in relation to the reservoir or the cover.

21. A measuring device according to claim 12, wherein the device comprises a plug cap (24) for connection of a plug (25) for the electric connecting line (9), in which in particular the measuring electronic system is attached, and the plug cap is displaceable or can be turned by a minimum angle about the longitudinal axis in relation to the reservoir or the cover.

22. A measuring device according to claim 12, wherein sealing of the electronics and the sensor area is provided by a shaped part which bears from inside against the housing wall of the electronics area in large parts in a form-fit manner, and the shaped part is an integral elastic seal in particular, or sealing is performed by at least one elastic sealing ring.

23. A measuring device according to claim 12, wherein a venting arrangement is provided in the sealing area of the cover.

24. A measuring device according to claim 12, wherein the electronics area is sealed towards the engine compartment by way of a plug extension (27) which additionally comprises a connecting plug (30) for the sensor connecting cable.
